(19) United States
(12) Patent Application Publication
(10) Pub. No.: US 2017/0267914 A1
(43) Pub. Date: Sep. 21, 2017

(54) ALKOXYLATED ALCOHOL COMPOSITION AND PREPARATION OF SAME

(71) Applicant: SHELL OIL COMPANY, HOUSTON, TX (US)

(72) Inventors: Lori Ann CROM, Houston, TX (US); Timothy Elton KING, Katy, TX (US); Julian Richard BARNES, Amsterdam (NL); Paulus Johannes KUNKELER, Voorhout (NL); David PEREZ-REGALDO, Amsterdam (NL)

(21) Appl. No.: 15/617,406

(22) Filed: Jun. 8, 2017

(51) Int. Cl. C09K 8/584; C09K 15/08

(52) U.S. Cl. CPC C09K 8/584; C09K 15/08

(57) ABSTRACT

The invention relates to an alkoxylated alcohol composition, wherein the composition comprises an alkoxylated alcohol which is of the formula (I) Formula (I) R—O—[PO]ₓ[EO]_{y}—H wherein R is a hydrocarbyl group which has a weight average carbon number of from 5 to 32, PO is a propylene oxide group, EO is an ethylene oxide group, x is the number of propylene oxide groups and is of from 0 to 40, y is the number of ethylene oxide groups and is of from 0 to 50, and the sum of x and y is of from 5 to 60; and wherein the composition additionally comprises a stabilizer which is a phenolic antioxidant. Further, the invention relates to a process for preparing said alkoxylated alcohol composition.

### FIELD OF THE INVENTION

The present invention relates to an alkoxylated alcohol composition and a process for preparing such composition.

### BACKGROUND OF THE INVENTION

Alkoxylated alcohols are known starting materials for making further chemical products, like for example surfactants. Fur example, an alkoxylated alcohol can be sulfated resulting in an alkoxylated alcohol sulfate (AAS). Such AAS may be used as a surfactant in methods of chemical Enhanced Oil Recovery (cEOR) for maximising the yield of hydrocarbons from subterranean reservoirs.

However, before an alkoxylated alcohol is further converted into another chemical product, for example into the above-mentioned AAS surfactant, it may have to be stored for a relatively long period of time. Such time period may include transporting the alkoxylated alcohol from its production facility to another, remote facility where it is further converted. Furthermore, such time period may involve storing the alkoxylated alcohol for months or even years (e.g. for different projects) before it is actually used. During such storage time period, the may partly decompose due to oxidation. It has been found that storing an alkoxylated alcohol (C12,13-13PO) in sealed drums for a year or so, without an anti-oxidant, results in significant deterioration of the product.

It is an object of the present invention to provide an alkoxylated alcohol composition wherein the alkoxylated alcohol has a relatively high long-term storage stability.

### SUMMARY OF THE INVENTION

Surprisingly it was found that a relatively high long-term storage stability for the alkoxylated alcohol may be obtained by adding a phenolic antioxidant as a stabilizer to the composition which comprises the alkoxylated alcohol.

The present invention relates to an alkoxylated alcohol composition, wherein the composition comprises an alkoxylated alcohol which is of the formula (I)

R—O—[PO]ₓ[EO]_{y}—H Formula (I)

wherein R is a hydrocarbyl group which has a weight average carbon number of from 5 to 32, PO is a propylene oxide group, EO is an ethylene oxide group, x is the number of propylene oxide groups and is of from 0 to 40, y is the number of ethylene oxide groups and is of from 0 to 50, and the sum of x and y is of from 5 to 60;

and wherein the composition additionally comprises a stabilizer which is a phenolic antioxidant.

Further, the present invention relates to a process for preparing an alkoxylated alcohol composition, comprising preparing an alkoxylated alcohol, providing a composition comprising the alkoxylated alcohol, and adding a stabilizer to the composition wherein the stabilizer is the above-mentioned phenolic antioxidant.

### DETAILED DESCRIPTION OF THE INVENTION

In the present invention, a phenolic antioxidant is added as a stabilizer to a composition comprising an alkoxylated alcohol. Such addition may result in that the long-term storage stability of the alkoxylated alcohol is advantageously increased. Furthermore, the presence of such phenolic antioxidant is expected not to have a negative effect in further conversion or use steps. An example where this was the case is one wherein the further conversion step is the above-mentioned sulfation of the alkoxylated alcohol resulting in an alkoxylated alcohol sulfate (AAS), which sulfation may be carried out in a falling-film process wherein the alcohol feed reacts with sulfur trioxide (SO₃). An example of such further use step is the above-mentioned subsequent use of said AAS as a surfactant in chemical Enhanced Oil Recovery (cEOR). In particular, it is expected that such phenolic antioxidant does not have a negative effect on aqueous solubility and/or oil/water phase behaviour of the surfactant. Said oil/water phase behaviour is measured in order to measure lowering of IFT (interfacial tension). An adequate aqueous solubility and lowering of IFT are important features for a surfactant, like said AAS surfactant, when uses in cEOR.

In the context of the present invention, in a case where a composition comprises two or more components, these components are to be selected in an overall amount not to exceed 100 wt. %.

Further, while the composition of the present invention and the process of preparing such composition are described in terms of “comprising”, “containing” or “including” one or more various described components and steps, respectively, they can also “consist essentially of” or “consist of” said one or more various described components and steps, respectively.

The composition of the present invention comprises a compound of the formula (I): R—O—[PO]ₓ[EO]_{y}—H. Said compound of the formula (I) is an alkoxylated alcohol. The composition of the present invention may comprise one or more alkoxylated alcohols of the formula (I). Further, the composition of the present invention comprises a stabilizer as further described below. In addition, said composition may comprise other components.

For example, the alkoxylated alcohol composition may additionally comprise an acid. For in the process to make an alkoxylated alcohol, normally an acid is added at the end of the process to neutralise the basic catalyst (e.g. potassium hydroxide, KOH). Generally, in the case of an ethoxylated alcohol, acetic acid is used. In the case of a propoxylated alcohol, preferably a sulfonic acid is used, for example a linear alkyl benzene sulfonic acid, like para-dodecylbenzene sulfonic acid. Adding a sulfonic acid to an alkoxylated alcohol is disclosed in WO2014086908, the disclosure of which is incorporated herein by reference. The objective of adding an acid to an alkoxylated alcohol is to neutralize residual basic catalyst, by which undesired side reactions may be prevented. After removal of water from an alkoxylated alcohol as prepared, a residual amount of water remains in the alkoxylated alcohol, which amount may be in the range of a few hundreds of parts per million by weight (ppmw). In the present invention, the amount of the phenolic antioxidant may be of from 1 ppmw to 1 wt. %, based on the total weight of the alkoxylated alcohol composition, suitably of from 10 ppmw to 5,000 ppmw, more suitably of from 30 ppmw to 1,000 ppmw, more suitably of from 50 ppmw to 500 ppmw, more suitably of from 70 to 250 ppmw, most suitably of from 100 to 200 ppmw.

For the above-mentioned compound of formula (I) (alkoxylated alcohol), the following applies in the present invention: R is a hydrocarbyl group which has a weight average carbon number of from 5 to 32, PO is a propylene oxide group, EO is an ethylene oxide group, x is the number of propylene oxide groups and is of from 0 to 40, y is the number of ethylene oxide groups and is of from 0 to 50, and the sum of x and y is of from 5 to 60.

The hydrocarbyl group R in said formula (I) is preferably aliphatic. When said hydrocarbyl group R is aliphatic, it may be an alkyl group, cycloalkyl group or alkenyl group, suitably an alkyl group. Preferably, said hydrocarbyl group is an alkyl group. Said hydrocarbyl group may be substituted by another hydrocarbyl group as described hereinbefore or by a substituent which contains one or more heteroatoms, such as a hydroxy group or an alkoxy group.

The non-alkoxylated alcohol R—OH, from which the hydrocarbyl group R in the above formula (I) originates, may be an alcohol containing 1 hydroxyl group (mono-alcohol) or an alcohol containing of from 2 to 6 hydroxyl groups (poly-alcohol). Suitable examples of poly-alcohols are diethylene glycol, dipropylene glycol, glycerol, pentaerythritol, trimethylolpropane, sorbitol and mannitol. Preferably, in the present invention, the hydrocarbyl group R in the above formula (I) originates from a non-alkoxylated alcohol R—OH which only contains 1 hydroxyl group (mono-alcohol). Further, said alcohol may be a primary or secondary alcohol, preferably a primary alcohol.

The non-alkoxylated alcohol R—OH, wherein R is an aliphatic group and from which the hydrocarbyl group R in the above formula (I) originates, may comprise a range of different molecules which may differ from one another in terms of carbon number for the aliphatic group R, the aliphatic group R being branched or unbranched, number of branches for the aliphatic group R, and molecular weight. Generally, said hydrocarbyl group R may be a branched hydrocarbyl group or an unbranched (linear) hydrocarbyl group. Further, preferably, said hydrocarbyl group R is a branched hydrocarbyl group which has a branching index equal to or greater than 0.2.

Preferably, the hydrocarbyl group R in the above formula (I) is an alkyl group. Said alkyl group has a weight average carbon number within a wide range, namely 5 to 32, more suitably 5 to 25, more suitably 7 to 22, more suitably 8 to 20, most suitably 9 to 16. In a case where said alkyl group contains 3 or more carbon atoms, the alkyl group is attached either via its terminal carbon atom or an internal carbon atom to the oxygen atom, preferably via its terminal carbon atom. Further, the weight average carbon number of said alkyl group is at least 5, preferably at least 6, more preferably at least 7, more preferably at least 8, more preferably at least 9, more preferably at least 10, more preferably at least 11, most preferably at least 12. Still further, the weight average carbon number of said alkyl group is at most 32, preferably at most 25, more preferably at most 20, more preferably at most 17, more preferably at most 16, more preferably at most 15, more preferably at most 14, most preferably at most 13.

Further, in the present invention, said alkyl group R in the above formula (I) is preferably a branched alkyl group which has a branching index equal to or greater than 0.2. By said “branching index”, the “average number of branches” as defined above is referred to. In the present invention, the branching index of said alkyl group R in the above formula (I) is preferably of from 0.2 to 3.5, more preferably 0.2 to 2.5, most preferably 0.2 to 1.5. Further, said branching index is preferably at least 0.2, more preferably at least 0.3, more preferably at least 0.5, more preferably at least 0.7, more preferably at least 0.9, more preferably at least 1.0, more preferably at least 1.1, most preferably at least 1.2. Still further, said branching index is preferably at most 3.5, more preferably at most 3.0, more preferably at most 2.5, more preferably at most 2.2, more preferably at most 2.0, more preferably at most 1.8, more preferably at most 1.6, most preferably at most 1.5. Said branches in such branched alkyl groups R may comprise methyl and ethyl branches.

The alkylene oxide groups in the above formula (I) comprise ethylene oxide (EO) groups or propylene oxide (PO) groups or a mixture of ethylene oxide and propylene oxide groups. In addition, other alkylene oxide groups may be present, such as butylene oxide groups. Preferably, said alkylene oxide groups consist of ethylene oxide groups or propylene oxide groups, preferably propylene oxide groups, or a mixture of ethylene oxide and propylene oxide groups. In case of a mixture of different alkylene oxide groups, the mixture may be random or blockwise, preferably blockwise. In the case of a blockwise mixture of ethylene oxide and propylene oxide groups, the mixture preferably contains one EO block and one PO block, wherein the PO block is attached via an oxygen atom to the hydrocarbyl group R.

In the above formula (I), x is the number of propylene oxide groups and is of from 0 to 40. In the present invention, the average value for x is of from 0 to 40, and may be of from 1 to 40, suitably of from 2 to 35, more suitably of from 3 to 30, more suitably of from 5 to 25, more suitably of from 10 to 20, most suitably of from 10 to 15.

Further, in the above formula (I), y is the number of ethylene oxide groups and is of from 0 to 50. In the present invention, the average value for y is of from 0 to 50, and may be of from 1 to 50, suitably of from 5 to 40, more suitably of from 9 to 35, more suitably of from 12 to 30, most suitably of from 15 to 25.

In the above formula (I), the sum of x and y is the number of propylene oxide and ethylene oxide groups and is of from 5 to 60. In the present invention, the average value for the sum of x and y is of from 5 to 60, and may be of from 15 to 50, suitably of from 20 to 45, more suitably of from 24 to 40, more suitably of from 28 to 37, most suitably of from 30 to 35.

In the present invention, y may be 0, in which case the alkylene oxide groups in the above formula (I) comprise PO groups but no EO groups. In the latter case, the average value for the sum of x and y equals the above-described average value for x.

In the present invention, x may be 0, in which case the alkylene oxide groups in the above formula (I) comprise EO groups but no PO groups. In the latter case, the average value for the sum of x and y equals the above-described average value for y.

Further, in the present invention, each of x and y may be at least 1, in which case the alkylene oxide groups in the above formula (I) comprise PO and EO groups. In the latter case, the average value for the sum of x and y may be of from 15 to 60, suitably of from 20 to 50, more suitably of from 23 to 40, most suitably of from 25 to 35.

In the present invention, x is preferably at least 1 and y is preferably 0, in which case the alkylene oxide groups in the above formula (I) comprise PO groups but no EO groups.

In the present invention, the alkoxylated alcohol of the above formula (I) may be a liquid, a waxy liquid or a solid at 20° C. In particular, it is preferred that at least 50 wt. %, suitably at least 60 wt. %, more suitably at least 70 wt. % of the alkoxylated alcohol is liquid at 20° C. Further, in particular, it is preferred that of from 50 to 100 wt. %, suitably of from 60 to 100 wt. %, more suitably of from 70 to 100 wt. % of the alkoxylated alcohol is liquid at 20° C.

The non-alkoxylated alcohol R—OH, from which the hydrocarbyl group R in the above formula (I) originates, may be prepared in any way. For example, a primary aliphatic alcohol may be prepared by hydroformylation of a branched olefin. Preparations of branched olefins are described in U.S. Pat. No. 5,510,306, U.S. Pat. No. 5,648,584 and U.S. Pat. No. 5,648,585. Preparations of branched long chain aliphatic alcohols are described in U.S. Pat. No. 5,849,960, U.S. Pat. No. 6,150,222, U.S. Pat. No. 6,222,077.

The above-mentioned (non-alkoxylated) alcohol R—OH, from which the hydrocarbyl group R in the above formula (I) originates, may be alkoxylated by reacting with alkylene oxide in the presence of an appropriate alkoxylation catalyst. The alkoxylation catalyst may be potassium hydroxide or sodium hydroxide which is commonly used commercially. Alternatively, a double metal cyanide catalyst may be used, as described in U.S. Pat. No. 6,977,236. Still further, a lanthanum-based or a rare earth metal-based alkoxylation catalyst may be used, as described in U.S. Pat. No. 5,059,719 and U.S. Pat. No. 5,057,627. The alkoxylation reaction temperature may range from 90° C. to 250° C., suitably 120 to 220° C., and super atmospheric pressures may be used if it is desired to maintain the alcohol substantially in the liquid state.

Preferably, the alkoxylation catalyst is a basic catalyst, such as a metal hydroxide, which catalyst contains a Group IA or Group IIA metal ion. Suitably, when the metal ion is a Group IA metal ion, it is a lithium, sodium, potassium or cesium ion, more suitably a sodium or potassium ion, most suitably a potassium ion. Suitably, when the metal ion is a Group HA metal ion, it is a magnesium, calcium or barium ion. Thus, suitable examples of the alkoxylation catalyst are lithium hydroxide, sodium hydroxide, potassium hydroxide, cesium hydroxide, magnesium hydroxide, calcium hydroxide and barium hydroxide, more suitably sodium hydroxide and potassium hydroxide, most suitably potassium hydroxide. Usually, the amount of such alkoxylation catalyst is of from 0.01 to 5 wt. %, more suitably 0.05 to 1 wt. %, most suitably 0.1 to 0.5 wt. %, based on the total weight of the catalyst, alcohol and alkylene oxide (i.e. the total weight of the final reaction mixture).

The alkoxylation procedure serves to introduce a desired average number of alkylene oxide units per mole of alcohol alkoxylate (that is alkoxylated alcohol), wherein different numbers of alkylene oxide units are distributed over the alcohol alkoxylate molecules. For example, treatment of an alcohol with 7 moles of alkylene oxide per mole of primary alcohol serves to effect the alkoxylation of each alcohol molecule with 7 alkylene oxide groups, although a substantial proportion of the alcohol will have become combined with more than 7 alkylene oxide groups and an approximately equal proportion will have become combined with less than 7. In a typical alkoxylation product mixture, there may also be a minor proportion of unreacted alcohol.

Non-alkoxylated alcohols R—OH, from which the hydrocarbyl group R in the above formula (I) for the alkoxylated alcohol originates, wherein R is a branched alkyl group which has a branching index equal to or greater than 0.2 and which has a weight average carbon number of from 5 to 32, are commercially available. A suitable example of a commercially available alcohol mixture is NEODOL™ 67, which includes a mixture of C₁₆ and C₁₇ alcohols of the formula R—OH, wherein R is a branched alkyl group having a branching index of about 1.3, sold by Shell Chemical Company. NEODOL™ as used throughout this text is a trademark. Shell Chemical Company also manufactures a C₁₂/C₁₃ analogue alcohol of NEODOL™67, which includes a mixture of C₁₂ and C₁₃ alcohols of the formula R—OH, wherein R is a branched alkyl group having a branching index of about 1.3, and which is used to manufacture alcohol alkoxylate sulfate (AAS) products branded and sold as ENORDET™ enhanced oil recovery surfactants. Another suitable example is EXXAL™ 13 tridecylalcohol (TDA), sold by ExxonMobil, which product is of the formula R—OH wherein R is a branched alkyl group having a branching index of about 2.9 and having a carbon number distribution wherein 30 wt. % is C₁₂, 65 wt. % is C₁₃ and 5 wt. % is C₁₄. Yet another suitable example is MARLIPAL® tridecylalcohol (TDA), sold by Sasol, which product is of the formula R—OH wherein R is a branched alkyl group having a branching index of about 2.2 and having 13 carbon atoms.

The stabilizer in the present alkoxylated alcohol composition is a phenolic antioxidant. Preferably, said phenolic antioxidant is a sterically hindered phenolic antioxidant.

In the present invention, any phenolic antioxidant may be used as the stabilizer. For example, the phenolic antioxidant may be one as disclosed in WO2006111492, the disclosure of which is incorporated herein by reference. In particular, in the present invention, the phenolic antioxidant may be one as disclosed in claim 2 and pages 2 to 11 of WO2006111492. In particular, said phenolic antioxidant may be the compound of the following formula (2,6-di-tent-butyl-4-octadecyl propionyl phenol), which is Irganox 1076 (commercially available at Ciba Specialty Chemicals Inc.).

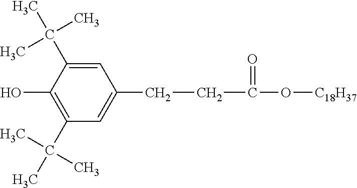

The book “Chemistry and Technology of Polyols for Polyurethanes” by Mihail Ionescu (Rapra Technology Limited, 2005) discloses the use of above-mentioned Irganox 1076 in stabilizing polyether polyols (see pages 134-137 of said book).

Further, suitable phenolic antioxidants which can be used as the stabilizer in the present invention, may be any phenolic antioxidant as disclosed at pages 517 to 522 of the “Handbook of Polyolefins”, Second Edition (Chapter 20: “Additives for Polyolefins”, by Cornelia Vasile), the disclosure of which is incorporated herein by reference. A particular suitable phenolic antioxidant disclosed therein is AN-2 (commercially available at Ethyl, USA), which is 4,4′-methylene bis (2,6-di-tent-butylphenol). Another particular suitable phenolic antioxidant disclosed therein is BHT (commercially available at Koppers, USA and at Monsanto, UK), which is 2,6-di-tent-butyl-4-methyl-phenol.

1. Alkoxylated alcohol composition, wherein the composition comprises an alkoxylated alcohol which is of the formula (I)
R—O—[PO]ₓ[EO]_{y}—H Formula (I)
wherein R is a hydrocarbyl group which has a weight average carbon number of from 5 to 32, PO is a propylene oxide group, EO is an ethylene oxide group, x is the number of propylene oxide groups and is of from 0 to 40, y is the number of ethylene oxide groups and is of from 0 to 50, and the sum of x and y is of from 5 to 60;
and wherein the composition additionally comprises a stabilizer which is a phenolic antioxidant.

2. The composition of claim 1, wherein the hydrocarbyl group R in formula (I) is an alkyl group having a weight average carbon number of from 10 to 15, and the alkoxylated alcohol comprises propylene oxide groups wherein the average value for the number of propylene oxide groups is of from 10 to 15.

3. The composition of claim 1, wherein the phenolic antioxidant is a sterically hindered phenolic antioxidant, in particular one having the following formula

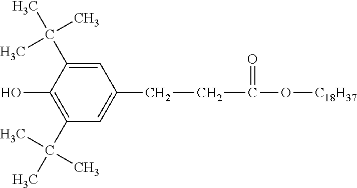

4. A process for preparing an alkoxylated alcohol composition, comprising preparing an alkoxylated alcohol, providing a composition comprising the alkoxylated alcohol, and adding a stabilizer to the composition wherein the stabilizer is as defined in claim 1.
